(19) United States
(12) Patent Application Publication
(10) Pub. No.: US 2014/0214676 A1
(43) Pub. Date: Jul. 31, 2014

(54) Automatic Learning Fraud Prevention (LFP) System

(71) Applicant: Dror Bukai, Caesarea (IL)

(72) Inventor: Dror Bukai, Caesarea (IL)

(21) Appl. No.: 14/166,852

(22) Filed: Jan. 28, 2014

Related U.S. Application Data
(60) Provisional application No. 61/758,241, filed on Jan. 29, 2013.

(51) Int. Cl. G06Q 20/40; G10L 17/00

(52) U.S. Cl. CPC G06Q 20/4016; G10L 17/00
USPC 705/44

(57) ABSTRACT

A computerized learning fraud prevention system and method for generating a voice signature of a user, such as one engaged in electronic commerce, to prevent fraudulent activities by machines and persons imitating the user. Steps comprise: fetching a signal of a user's signature stored in memory; generating at least one challenge sequence based on the signal to create a second signature; presenting the generated challenge sequence to the user; collecting the user's challenge voice response to the generated challenge sequence; computing a quality factor between the user's challenge response and the generated challenge sequence; computing a transaction quality factor and content quality factor and reporting an impostor or re-challenging if the quality factor is below a threshold. Lastly, generating new signature based on any portion of user's challenge voice response and/or any portion of the previously generated signature and/or any portion of collectable information from user's device memory.

### PRIORITY CLAIM

This application claims priority to U.S. Provisional Application 61/758,241 filed Jan. 29, 2013 by Dror Bukai and entitled “Automatic Learning Fraud Prevention System”, the entirety which is herein incorporated by reference.

### FIELD OF THE INVENTION

Embodiments of the invention relate, in general, to the field of eCommerce Fraud Prevention (EFP), and more particularly to a use of automatic learning voice forensics system for EFP in order to rebuttal persons or programs masquerades as another by falsifying data. Automatic learning EFP assesses risk and “red-flags” probable fraudulent online transactions to allow for fraudulent transaction rejection and further analysis.

### BACKGROUND OF THE INVENTION

The field of EFP has become increasingly important in today's society. Hundreds of millions of online transactions take place every day. Cyber criminals, impostors, purchase goods at virtual stores using stolen credit card information and still merchandise that amounts to humongous dollar value. eCommerce, purchasing over the Internet through a desktop computer, a laptop, a tablet, a mobile phone or any other device conveying content to viewers through a screen display and allowing interaction with such content through such device is not secured. It lacks effective means to combat impostors. EFP plays a significant role in providing buyers intuitive means to assist in combating fraud. Automatic learning EFP (LFP) helps challenging impostors by putting smart obstacles in their way. LFP process responses to those smart obstacles from legitimate buyers and impostors and tell merchants which electronic transactions are risky. By doing so, LFP promotes trust in eCommerce and may lead to commerce growth. Buyers' confidence in merchants will grow, knowing merchants are doing everything commercially possible to protect their purchases. Merchants will attract more buyers and grow their revenue because they will become trusted entities in the process. Credit card clearing and processing companies will prefer trusted merchants that use LFP to minimize their fraud exposure.

### SUMMARY OF THE INVENTION

State of the art online fraud prevention utilize means to identify impostors, either persons or machines, botnets, by detecting suspicious behavior and/or suspicious end devices and/or channels, through which transactions are made. One such innovative approach to detect fraudulent use of credit card information by impostors is by deep inspection of the transaction originating device and comparing it to a signature of the device. A learning fraud prevention (LFP) system goes beyond the state of the art solutions by challenging buyers with sophisticated challenge sequences of objects, characters, numbers, words, phrases, sentences and any combination thereof, to respond by voice and documenting their responses. Over time, LFP learns to detect impostors by finding mismatches between legitimate and non-legitimate behavior. The state of the art is based on an assumption that legitimate purchases are made through legitimate machines. One problem with the state of the art solutions is their inability to assess correctly if a person is impersonating another person. In contrast, LFP presents unparalleled opportunity to assess buyer authenticity correctly.

An embodiment of the invention encompasses voice pattern analytics and recognition. Another embodiment of the invention encompasses voice pattern generation. Another embodiment of the invention encompasses the voice pattern generation in correlation with the voice pattern analytics. Another embodiment of the invention encompasses at least one voice pattern analytics association with a specific purchasing entity, known buyer. The entity may be correlated to a person. The entity may be correlated to a business or a trusted group of persons. For example, a signature of voice signal characteristics, voice features, represents at least one online buyer who controls a transaction through a web page of a virtual store, i.e. a known buyer. For example, the voice signature may comprise a plurality of voice signatures. For example the plurality of voice signatures of a specific entity may comprise multiple signatures each correlated with the same content, say YY. For example the plurality of voice signatures of a specific entity may comprise multiple signatures each correlated with different content, say YY, ZZ, AA, BB, etc.

The voice signature is speaker dependent. The voice signature may be content dependent. The signature may be content independent. One embodiment of the invention encompasses content independent voice pattern analysis and signature matching. One embodiment of the invention encompasses content dependent voice pattern analysis and signature matching. One embodiment of the invention encompasses both content independent and content dependent signature matching in tandem, which improves the false reject ratio and false accept ratio, enabling the voice pattern analysis to generate optimal quality factor for the transaction.

For example, the matching in tandem may be launched to shorten processing time and system resources by first running short time processes that are less demanding in system resources (e.g., processing and memory) utilization and then deploy more demanding algorithms only for those transactions in question where a quality factor is below a threshold. One embodiment of the invention encompasses both content independent and content dependent signature matching in parallel. For example, the content dependent and content independent signatures matching through voice pattern analysis may be deployed in parallel in cases of available resources. For example, such parallel processing may be performed for selected high risk transactions.

One embodiment of the invention applies a quality factor to each voice signature matching process output. The transaction quality factor, may, according to one embodiment of the invention become instrumental in a decision to accept or reject an online transaction. According to one embodiment of the invention, the transaction quality factor may be used in a voice pattern generation.

Voice pattern generator encompasses according to one embodiment of the invention challenge pattern generation that is derived from a known voice signature. For example, LFP may hold a voice signature of a person XX who said the word YY so that the voice pattern generator, which can generate voice phrases ZZ and BB, may generate a challenge pattern of the form ZZYYBB and a challenge YYZZBB. One embodiment of the invention encompasses a pseudo random challenge sequence. For example, the pseudo random sequence is presented to a buyer on a purchasing web store page or by playback of the challenge sequence to earphones or loudspeakers.

One embodiment of the invention encompasses outbound calling application interface. The interface allows for outbound calling to a buyer specified phone number. For example, the buyer answers a call at his mobile phone and speaks a challenge sequence back to LFP.

One embodiment of the invention encompasses random length silence generator to generate a challenge sequence of spoken content with random length silence periods embedded in it. One embodiment of the invention encompasses mechanism(s) to embed in challenge sequences objects. For example, such as a picture or an image (e.g. cat). Appropriate challenge sequence objects further comprise: an image containing text, such as one to make it hard to read by machines. For example; a video clip, such as one to make content impossible to read by machines. For example; an animation. For example; an advertisement with any audiovisual format that fits user environment, such as a computer screen and speakers. For example; visual effect of display. For example, such as changes color of display background.

The buyer needs to react to the challenge sequence by speaking through a microphone (herein ‘spoken sequence’). For example, buyer XX says a challenge sequence YYZZBB. For example, buyer XX say a challenge sequence YY wait TT time then say content ZZ then wait another PP time, then say phrase BB. For example, buyer XX say a challenge sequence YY wait TT time then say CAT (content object is an image) then wait another PP time, then say phrase BB. The use of multi-modal challenge sequence generation increases probability of combating machines and programs.

The spoken sequence is converted to a digital representation of a speech signal, and the speech signal is recorded. One embodiment of the invention encompasses speech signal features extraction. The features may correlate with previously recorded voice signatures. For example, the recorded speech signal is transferred to voice pattern analysis. For example, the voice pattern analysis performs truncation of the recorded voice pattern. For example, the voice pattern analysis performs isolation of the recorded signatures in the voice pattern. For example, the voice pattern analysis performs order matching between the recorded voice pattern and the generated voice pattern. For example, the voice pattern analysis generates non-match quality signal in case the generator challenge sequence, say ZZTTYYPPBB does not match the order of the spoken sequence (recorded voice pattern), say YYTZZPPPPBB. For example, the content independent voice pattern matching may yield a non-match signal prior to voice truncation. For example, the content independent voice pattern matching may yield a non-match signal prior to the order matching.

One embodiment of the invention encompasses generation of the non-match signal to alert that a possible impostor of a transaction is a machine. One embodiment of the invention encompasses generation of the non-match signal to alert that a possible impostor of a transaction is a person impersonating a known buyer.

Another embodiment of the invention encompasses a direct sequence generator in conjunction with a voice pattern analysis. For example, the recorded voice signature is mixed with a secret direct sequence signal to encrypt it prior to storage. Another embodiment of the invention encompasses an encryption key generator in conjunction with a voice pattern analysis. For example, the recorded voice signature is encrypted prior to storage. For example, the encrypted voice signature can be reconstructed for matching by utilizing pair key or mixing it with the direct sequence again. One embodiment of the invention encompasses at least one encryption mechanism to disable synthesis of voice signatures by machines. For example, machines are not able to economically generate a voice signature signal mixed with a direct sequence signal which resembles white noise. One embodiment of the invention encompasses means of voice pattern analysis to mix the generating direct sequence with recorded signals. For example, the mixing and analysis produces a voice signature similar to the encrypted signature. For example, the encryption decryption mechanisms are managed to insure security of voice signatures data bank and combat spoofing and/or alterations.

One embodiment of the invention encompasses collection of a plurality of voice signatures of each known buyer over time, thus growing voice pattern analysis knowledge and enhancing anti-fraud performance. For example, the buyer visits a virtual store for the first time. LFP challenges this person with a sequence. The buyer speaks the challenge sequence into the LFP system through a microphone. The speech signal is possibly recorded and transmitted to LFP voice pattern analysis. No feedback signal, quality factor may be generated by the analysis at that time since there is no voice signature to compare to. Voice pattern analysis may extract and record voice features of the first voice signature. The voice analysis may generate a quality signal to notify merchant of a first time buyer to allow buyer to minimize risk by limiting transaction magnitude or trigger other means to ensure that the first time buyer is not an impostor. One embodiment of the invention encompasses a speaker stress analysis mechanism. For example, the stress analysis generates quality factors to trigger further risk assessment if speaker shows fear and/or stress characteristics reflected in the spoken sequence. One embodiment of the invention encompasses re-challenging mechanism to combat first time machine masquerade through random sequencing of challenges. For example, if a machine or a program impersonates a first time buyer, it will be rebuttal with random sequence or sequences that are impossible or hard to fake without notice of the voice pattern analysis.

One embodiment of the invention encompasses a bookkeeping mechanism to allow for audit trail for all transactions in accordance with laws. One embodiment of the inventions encompasses unique identification mechanism of each transaction and each voice signature associated with the transaction. For example, the identification is encrypted. For example, the identification is scrambled to make it impossible to associate information to a person without a proper deciphering mechanism.

One embodiment of the invention encompasses a feedback mechanism to allow for reclassification of a specific voice signature of a specific transaction as fraudulent. For example, if a first time signature is made by an impostor, a person, a program or a machine and if voice pattern analysis did not flag the transaction as risky, and the voice features were saved as a first time buyer voice signature in a “WhiteList”, LFP allows for post mortem reclassification of the voice signature as fraudulent and clears it from the white-list of valid signatures. One embodiment of the invention encompasses a bank of fraudulent voice signatures, “BlackList” Another embodiment of the invention encompasses a mechanism to compare received voice signature to fraudulent signatures in the bank. For example, the mechanism of black-list matching may be employed in parallel with voice pattern analysis matching to good, known voice signatures of the white-list, to increase system performance. For example, the “blacklist” search mechanism may be employed in tandem to a “white list” matching to improve LFP system performance, in certain cases of marginal whitelist quality factor or in every case resources permit.

One embodiment of the invention encompasses a noise reduction mechanism. Another embodiment of the invention encompasses a voice recording cleaning and normalization prior to features extraction and voice pattern analysis. For example, the noise refers to one or more of the following: background noise; ambient noise; voice channel noise; human physiological noise; and voice imperfections as a result of illness and/or tiredness or fatigue and/or hoarseness.

One embodiment of the invention encompasses means to record transaction source device unique parameters in association with the recorded voice signature. An embodiment of the invention encompasses a performance analytics mechanism. For example, the performance analysis comprises quality factor analysis. The analysis may involve analysis of any number of elements of a transaction, such as source device, originating territory and communications characteristics. The quality factor analysis enables examination of voice signatures changes over time. For example, the analysis over time allows for identification of quality deterioration or fluctuations between consecutive transactions. One embodiment of the invention encompasses a quality signal generation that spans a plurality of consecutive transactions.

One embodiment of the invention encompasses means to report quality factor behavior at any specific time window. For example, the report may be produced for any specified user or for any specified group parameters. For example, the report may be produced for a territory. For example, the report may assist in detecting fraud attacks originated at a specific territory. For example, the report may be produced for a specific source device, say a specific mobile phone.

The LFP system is directed to the problem of fraudulent electronic commerce transaction risk assessment by way of integration of, but not limited to, at least one of the following user related information elements: user information posted in public records such as social networks, user related information published in public records such as blogs, user related information published in public records such as social media, user related information shared by user onto LFP through forms, user related information shared by user onto LFP through interactive questions and answers sessions, user related information shared by user onto LFP through challenge responses, user related information submitted onto LFP through customer service representatives. An embodiment of the invention encompasses events correlation mechanism that checks for use abnormalities of a user. For example, the correlation mechanism checks if a user posts in a social network while the user is in LFP process. For example, the correlation mechanism checks if a user posts a location while the user is in LFP process originating at another location. For example, the location can be extracted from a user mobile phone. For example, the location can be a specific region extracted from a user originating IP address. For example, the correlation mechanism checks user's spouse name and location from public or LFP records in comparison with responses to LFP challenge question. For example, the correlation mechanism checks time length of transaction, repetition of visiting a transaction, time lapse between repeated transaction, distribution of transaction locations, speed of movement within same transaction location area, speed of movement between different transaction location areas. For example, correlation mechanism assess user authenticity based on changes in one or more of the correlation elements over time, from the time prior to the transaction through the time the transaction is no longer processed.

One embodiment of the invention encompasses analysis of speaker interest in content presented to him. For example, LFP assesses viewer interest in content through a movie timeline by any number of the voice features analysis elements. For example, LFP analytics assesses speaker interest in an advertisement located within a movie. For example, LFP analytics assesses speaker interest in an advertisement located within an animation. For example, LFP analytics assesses speaker interest in an advertisement located within an image. For example, LFP analytics assesses speaker interest in an advertisement located within a full screen display of any number of content elements. For example, LFP analytics assesses speaker interest through statistical analysis of at least one analysis element.

LFP analytics may integrate with the analysis elements any available information about a speaker in assessing speaker interest. For example, LFP analytics may integrate with the analysis elements a speaker gender. For example, the analytics may integrate with the analysis elements a viewer location. For example, the analytics may assess based on analysis elements and a speaker gender and a speaker location that speaker is interested in a nearby women hair salon.

An embodiment of the invention utilizes analytics based on data collected for one anonymous speaker. Another embodiment of the invention utilizes analytics based on data collected for one specific speaker. Another embodiment of the invention utilizes analytics based on data collected for a plurality of anonymous speakers. Another embodiment of the invention utilizes analytics based on data collected for a plurality of specific speakers. For example, a plurality of specific speakers may be known by at least one identifying information, such as gender. For example, a specific speaker may be known by at least one identifying information such as email address.

An embodiment of the invention utilizes analytics to calculate a content quality factor. Content quality factor may be a multi-dimensional array of content quality factors. For example, a content quality factor may rank adequacy of content for a specific speaker gender. For example, a content quality factor may rank adequacy of content for a specific speaker age. For example, a content quality factor may rank adequacy of content for a specific speaker identification. For example, a content quality factor may rank adequacy of content for a specific speaker name. For example, a content quality factor may rank monetary value of content. For example, a content quality factor may rank keywords that represent content.

An embodiment of the invention makes the content quality factor available in real time for at least one speaker interest assessment. For example, advertisement may be served based on the quality factor in real time to the speaker.

An embodiment of the invention makes the content quality factor available in real-time for controlling content presented to the speaker. For example, content presented to the speaker, not necessarily a challenge sequence, may be correlated with content quality factor such as a keyword rank. For example, controlling includes replacement of content presented to a speaker; and/or changing parameters of content presented to speaker, such as color or background color or order in a sequence of content elements. For example, a speaker reacts vocally to a movie of a singer, the analytics generates a content quality factor ranking the singer as favorable to the speaker, thus, the controlling include presenting of advertisements related to the singer, such as a discount coupon for singer performance in vicinity to the speaker location. For example, the advertisement is presented immediately after the speaker saw the movie challenge sequence. For example, the advertisement may be presented after the speaker navigated to another web page. For example, the advertisement may be presented after the speaker logged on to the speaker computer in another occasion.

Analytics data may be stored for further analysis.

Analytics data may be retrieved for analysis.

Analytics content quality factor may be stored for analysis.

Analytics content quality factor may be retrieved for analysis.

An embodiment of the invention utilizes analytics on a device co-located with a speaker. For example, the co-located device may comprise a mobile phone. For example, the co-located device may comprise a desktop computer. For example, the co-located device may comprise a tablet computer. Another embodiment of the invention utilizes analytics on a computing device dislocated from a speaker. For example, the dislocated computing device may comprise a cloud computing platform.

Analytics may be performed in real time. For example, an advertisement of a product related to a specific content may be presented to a speaker in response to content quality factor generation in real time.

Analytics may be performed off line. For example, content quality factor may be generated based on statistical analysis over a period of time. For example, women react to advertisements with kids more passionately than men by a factor of two.

### BRIEF DESCRIPTION OF THE DRAWINGS

To provide a more complete understanding of the present invention and features and advantages thereof, reference is made to the following description, taken in conjunction with the accompanying FIG.s, wherein like reference numerals represent like parts, in which:

FIG. 1 is a block diagram of an automatic learning fraud prevention system in accordance with one embodiment of the present invention; and

FIG. 2 is a flowchart diagram presenting speaker authentication process in accordance with one embodiment of the present invention; and

FIG. 3 is a use-case scenario chain of events diagram in accordance with one embodiment of the present invention; and

FIG. 4 is a chain of events control diagram presenting an ad serving use-case in accordance with one embodiment of the invention For example.

### DETAILED DESCRIPTION OF EMBODIMENTS OF THE INVENTION

### System Architecture

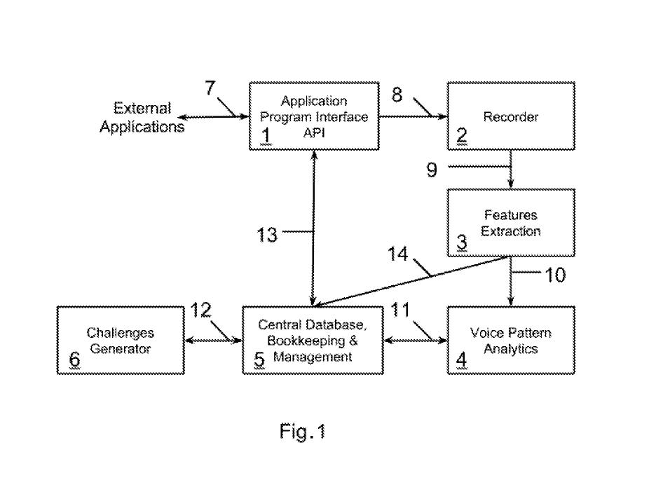

FIG. 1 is a block diagram of an automatic learning fraud prevention (LFP) system in accordance with one embodiment of the present invention, comprising an application program interface (API) (Block 1); a recorder (Block 2); a features extraction (Block 3); a voice pattern analytics (Block 4); a central database storing bookkeeping and management data (Block 5); a challenge generator (Block 6); and external applications (Block 7).

Block 1 represents a means for interfacing with external programs for collecting at least one of user identification information, and spoken sequence information. The user identification information may involve at least one or more of user location, user identification number, user credit card number, user telephone number, user home address, user work address, user work company name, user car license plate number, user secret password, user secret questions and answers, speaker voice signal. For example, user identification information may include a time stamp and speaker id and location.

Block 1 collects through connection 7 user identification information from at least one of, but not limited to: a Virtual web store, web page, web application, search engine such as Google® or Bing®, social networks such as Facebook® or LinkedIn®, Ad Server, CRM Server, End-User Device such as desktop computer, laptop computer, tablet computer, mobile phone. An embodiment of the invention corresponds to Block 1 collecting source device unique parameters. For example, Block 1 may collect a user gender, a location, and/or a voice transmission channel type.

Block 5 (e.g. a local or remote server) may convey to Block 1 through connection 13, control signals to assist Block 1 in collecting the information. For example, Block 5 triggers a collection by Block 1 from social networks or through a search engine API and a specific search pattern such as <search web for “user full name>”. For example, Block 1 may comprise a Java Script or a Flash Client program or a widget, embedded into a web page of a merchant through which a user purchases goods on the Internet. For example, Block 1 may be fully co-located with buyer or distributed in part, co-located with user/buyer web client and/or dislocated from user/buyer web client onto remote server or servers at a hosting facility and/or in the cloud.

An embodiment of the invention corresponds to Block 1 conveying to Block 2 through connection 8, voice signals and associated user identification information. An embodiment of the invention corresponds to anti-spoofing measures enforcement over at least connections 8, 9 and 13 by means of one or more, but not limited to the following measures: virtual private network connections, SSL connections, encryption, scrambling. An embodiment of the invention corresponds to Block 2 recording voice signals of spoken challenge sequences. An embodiment of the invention corresponds to Block 2 associating recordings of voice signals with speaker identification information. An embodiment of the invention corresponds to Block 1 conveying to Block 5, through connection 13, any of but not limited to, source device unique parameters, voice signals' attributes associated with speaker identification information for storage in database, management and bookkeeping of events and actions per each electronic transaction and each user. An embodiment of the invention corresponds to Block 1 employing voice activity detection techniques and conveying to Block 5 voice analysis parameters that may comprise, but not be limited to, at least one of the following measurement elements: Time length of speech of a challenge sequence, wait time between challenge sequence display and speaker vocal response, time lapse between voice response end-time and followed action, speed of response to a newly presented content.

An embodiment of the invention corresponds to Block 2 co-located with user web interface device. Another embodiment of the invention corresponds to Block 2 partially co-located with user web interface device and partially dislocated from user web interface device. Another embodiment of the invention corresponds to Block 2 completely dislocated from user web interface device, in the cloud or another server location. An embodiment of the invention corresponds to Block 2 generating a digital file that contains a lossless recording of speaker voice of spoken challenge sequence. For example, the digital file of recorded voice is a way file. For example, the digital file of recorded voice is named using a unique identification of the recorded speaker. For example, the digital recorded voice file's unique name is provided by Block 5 to Block 1 through connection 13 and through Block 1 one to Block 2 through connection 8. For example, the digital recorded voice file's unique name is provided by Block 1 to Block 5 through connection 13 and to Block 2 through connection 8. An embodiment of the invention corresponds to Block 2 conveying to Block 3 through Connection 9 a speaker voice recording. The speaker is the user of an electronic transaction of the merchant.

Block 3, Features Extraction, calculates voice features and parameters that correspond to a speaker unique characteristics, i.e. voice signature parameters. The LFP system looks through Block 3 and Block 4 at voice features comprising, for example: large variability between different speakers and small variability for the same speaker, features that are robust against noise and distortion, that occur frequently and naturally in speech, are economical in time and resources to measure, features that are difficult to impersonate/mimic, and are not affected by speaker's health or long-term variations in voice.

An embodiment of the invention corresponds to Block 3 calculating voice features and parameters that correspond to transaction unique characteristics. An embodiment of the invention corresponds to Block 3 comprising at least one voice filtering and analysis technique, including but not limited to, short-framing, pre-emphasizing, smoothing, fast Fourier transform (FFT, DFT), noise reduction or suppression, activity detection (VAD), dynamic adaptive separation of speech and noise, voice enhancement, segmentation, mel-frequency cepstral coefficients (MCC, MFCC), linear prediction cepstral coefficients (LPCC), line spectral frequencies, perceptual linear prediction (PLP), cepstral mean normalization (CMN), feature warping, Gaussianization, relative spectral filtering (RASTA), frequency estimation, short term spectral envelope i.e. timbre of sound, pitch detection, energy duration, rhythm, temporal features, glottal pulse shape and features and fundamental frequency, delta and double delta, amplitude modulation frequency, Temporal discrete cosine transform (TDCT), frequency demodulation (FM), prosodic fundamental frequency (F0), pause statistics, phone duration, speaking rate, energy distribution, energy modulation, hidden Markov models (HMM for text dependent), Gaussian mixture models (GMM), supervectors mapping (SVM), patterns matching, vector quantization, likelihood analysis, neural networks, fusion, score normalization and decision trees.

An embodiment of the invention corresponds to Block 3 comprising at least one extraction capability of text dependent and text independent voice features. For example, text dependent voice features may include spoken words extraction. An embodiment of the invention corresponds to Block 3 employing background audio model associated with the transaction. An embodiment of the invention corresponds to Block 3 employing background audio model associated with the speaker.

An embodiment of the invention corresponds to Block 3 employing background audio model associated with the voice channel. An embodiment of the invention corresponds to Block 3 employing voice activity detection techniques and conveying to Block 5 through connection 14, voice analysis parameters that may comprise, but not be limited to, at least one of the following measurement elements: the text independent speaker dependent voice features, the text dependent speaker dependent voice features, the background model features, time length of speech of a challenge sequence, wait time between challenge sequence display and speaker vocal response, time lapse between voice response end-time and followed action, speed of response to a newly presented content.

An embodiment of the invention corresponds to Block 3 conveying to Block 4 through connection 10, the voice features and parameters of the speaker for further analysis. Another embodiment of the invention corresponds to Block 5 conveying to Block 4 through connection 11, the voice features and parameters of the speaker and the background model for further analysis.

An embodiment of the invention corresponds to Block 4 comprising of at least one but not limited to the following techniques for voice pattern analytics: mel-frequency cepstral coefficients analysis (MFCC), linear prediction cepstral coefficients analysis (LPCC), line spectral frequencies analysis, perceptual linear prediction analysis (PLP), cepstral mean normalization analysis (CMN), feature warping, Gaussianization, relative spectral filtering (RASTA), frequency estimation, short term spectral envelope analysis, pitch statistics, energy duration statistics, rhythm statistics, temporal features analysis, glottal pulse shape and features and fundamental frequency analysis, delta and double delta analysis, amplitude modulation frequency analysis, Temporal discrete cosine transform analysis (TDCT), frequency demodulation (FM) deviation analysis, prosodic fundamental frequency (F0) analysis, pause statistics, phone duration statistics, speaking rate statistics, energy distribution statistics, energy modulation statistics, hidden Markov models analysis (HMM), spoken words matching to challenge sequence, Gaussian mixture models (GMM) analytics, supervectors mapping (SVM) analytics, patterns matching, vector quantization, likelihood analysis, neural networks, fusion, score normalization and decision trees, to generate decision quality factors.

Quality Factors:

The quality factors may be text dependent. The quality factors may be text independent. An embodiment of the invention encompasses Block 4 speaker stress analysis mechanism. For example, the stress analysis generates quality factors to trigger further risk assessment if a speaker shows fear and/or stress characteristics reflected in the spoken sequence. An embodiment of the invention corresponds to Block 3 and Block 4 comprised in part or as a whole of commercial off the shelf programs for speaker recognition. For example, a text independent speaker authentication tool kit, VoiceGrid™, by Speech Technology Center, may be used. An embodiment of the invention corresponds to Block 4 fetching voice signature history or reference data from Block 5 through connection 11. The information data may comprise any number of voice features data from whitelists and blacklists as might have been accumulated over time. The information data may comprise any number of voice features data of background model. The information data may comprise any number of voice features data of voice channel. The reference data is processed with newly created voice features analytics to generate the quality factors.

An embodiment of the invention corresponds to Block 4 fetching reference challenge sequence data from Block 5 through connection 11. The sequence data is processed against newly created voice features analytics to generate the quality factors. For example, Block 4, voice pattern analysis, performs order matching between the recorded voice pattern and the generated challenge sequence. For example, the voice pattern analysis generates non-match quality signal in case the generator challenge sequence, say ZZTTYYPPBB does not match the order of the spoken sequence (recorded voice pattern), say YYTZZPPPPBB. The T is a silent period. The P is a silent period. The YY, ZZ and BB are phrases.

An embodiment of the invention corresponds to Block 4 conveying analytics data to Block 5 through connection 11. The analytics data may comprise quality factors. The quality factors may be processed by Block 5 to generate hard speaker authentication decision. The quality factors may be processed by Block 5 to generate soft speaker authentication decision. An embodiment of the invention corresponds to Block 4 conveying to Block 5 the voice features for storage and further analysis.

Another embodiment of the invention corresponds to Block 5 calculating quality factors based on the voice features and previously stored speaker related voice signature information. An embodiment of the invention corresponds to Block 5 conveying to an external host application the decision through connection 13 to Block 1 and through connection 7 to external applications. An embodiment of the invention corresponds to Block 5 conveying to an external host application the quality factors through connection 13 to Block 1 and through connection 7 to external applications.

External Applications:

An embodiment of the invention corresponds to Block 5 conveying to an external host application trigger for action through connection 13 to Block 1 and through connection 7 to external applications. The trigger for action may, for example, start a call-back procedure through which a user mobile phone is called automatically by a system for real-time verification by an agent in cases the quality factors represent high risk of transaction approval.

For example, the buyer answers a call at his mobile phone and speaks a challenge sequence back to LFP. The LFP system is directed to the problem of fraudulent electronic commerce transaction risk assessment by way of Block 5 processing of, but not limited to, at least one of the following user related information elements: user information posted in public records such as social networks, user related information published in public records such as blogs, user related information published in public records such as social media, user related information shared by user onto LFP through forms, user related information shared by user onto LFP through interactive questions and answer sessions, user related information shared by user onto LFP through challenge responses, and user related information submitted onto LFP through customer service representatives.

An embodiment of the invention corresponds to Block 5 correlation of events for abnormalities detection for a specified user. For example, Block 5 correlation mechanism checks if a user posts in a social network while the user is in LFP process. For example, the correlation mechanism checks if a user posts a location while the user is in LFP process originating at another location. For example, the location can be extracted from a user mobile phone through Block 1. For example, the location can be a specific region extracted from a user originating device IP address. For example, the correlation mechanism generates a trigger to re-generate a challenge question. For example, the correlation mechanism checks time length of transaction, repetition of visiting a transaction, time lapse between repeated transaction, distribution of transaction locations, speed of movement within same transaction location area, speed of movement between different transaction location areas. For example, correlation mechanisms assess user authenticity based on changes in one or more of the correlation elements over time, from the time prior to the transaction through the time the transaction is no longer processed.

An embodiment of the invention corresponds to Block 5 conveying to Block 6 trigger for sequence generation through connection 12. The trigger for challenge sequence generation may, for example, result in a procedure through which a user is re-challenged automatically by LFP for real-time re-verification in cases the quality factors represent high risk of transaction approval.

An embodiment of the invention corresponds to Block 1 conveying to Block 5 through connection 13 a trigger to fetch a challenge sequence for the user. For example, after a user submits identification information such as, but not limited to id number and/or credit card number and/or a full name, Block 1 receives such information from an external host application through connection 7 and conveys the information to Block 5 through connection 13. As a result, Block 5 conveys to Block 6 through connection 12 a request for a new challenge sequence. The sequence is then conveyed back to Block 5 by Block 6 through connection 12 and from Block 5 to Block 1 through connection 13 and by Block 1 to an external host application through connection 7. The challenge sequence is then presented to a user on a screen display or through loudspeakers audibly by either Block 1 or its external host application. An embodiment of the invention corresponds to Block 6 fetching information from Block 5 database through connection 12 in order to assemble a challenge sequence. The information may correspond to the user. The information may correspond to the transaction. The information may correspond to the voice features. The information may correspond to the quality factors. For example, the voice feature may be a spoken word. The information may correspond to the pre-used challenge sequence. The information may correspond to a format of challenge sequence. The format of sequence may comprise but not be limited to any number of characters, syllables, words, phrases, sentences, objects, images, video clips, animations, and any combination thereof.

An embodiment of the invention corresponds to Block 6 generating challenge sequences based in part or in whole on information fetched from Block 5. For example, the Block 5 randomly selects an object from an array of objects fetched from Block 5 and locates it within a challenge sequence. For example, Block 6 generates a sequence of random length silent periods embedded with words fetched from Block 5. For example, objects fetched from Block 5 may correspond to user related secret information. For example, Block 6 fetched from Block 5 a user location and Block 6 generates a challenge sequence such as “My current location is <fetched user location> but I live in <fetched user home address>”.

An embodiment of the invention corresponds to Block 5 managing LFP bookkeeping and process management. Another embodiment of the invention encompasses encryption voice features, signatures, user information and transaction information to protect data from spoofing and alteration. For example, the recorded voice signature is encrypted prior to storage. The management includes management of whitelists of known original users and their information and voice signatures, and blacklists of impostors' voice signatures and information. Block 5 augments voice signature to accumulate history data for each user and impostor. For example, the augmented voice signatures over time and transactions assists Block 4 and/or Block 5 improve speaker authentication performance over time.

Global Signature Bank:

An embodiment of the invention corresponds to Block 5 managing a global voice signature bank for any merchant that implements a connection through Block 1 and connection 7. The voice signature bank is unique by comparison to state of the art speaker recognition systems in that it created reference signature data across merchants' walls and enable reuse of the data. For example, some existing speaker identification systems are implemented for a specific enterprise contact center. Their collected voice signatures could not serve to detect imposters in other enterprises. By contrast, the invention allows for imposter of a transaction of merchant WQ be detected in a transaction of another merchant QA at another time, because the data exists in the global signature bank.

Reports:

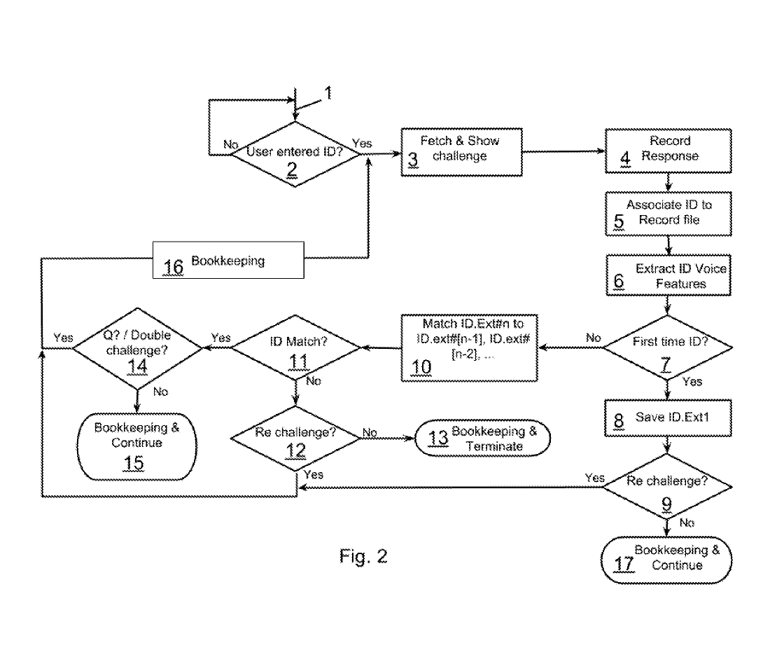

The LFP system's process management and bookkeeping is presented in FIGS. 2, 3 and 4. An embodiment of the invention corresponds to Block 5 generating an audit trail of all transactions, all users and all actions by time, actions and actors of each action. An embodiment of the invention corresponds to Block 5 generating statistical analysis data by any attribute of a transaction speaker authentication, such as but not limited to, time periods, users, actions, transactions, locations, quality factors, voice features, spoken words, challenge sequences, channel types. For example, Block 5 may generate a report to assist in detecting fraud attacks originated at a specific territory. For example, the report may be produced for a specific source device, say a specific mobile phone. The report may be conveyed by Block 5 to Block 1 through connection 13 and then to external applications through Block 1 and connection 7.

An embodiment of the invention corresponds to Block 5 generating quality factors based on the statistical analysis data. An embodiment of the invention corresponds to Block 5 generating advertising content based on the statistical analysis data. For example, the advertising content may be a coupon to a singer performance if Block 5 detects that a spoken challenge sequence was “My favorite singer is <user generated content> and I would love to go to its performance if it's nearby.” and, Block 5 detects that user location is where the singer <user generated content> is 5 times out of 6 the name of a singer that will have a performance shortly.

Machine Fraud Detection:

An embodiment of the invention encompasses re-challenging mechanism to combat first time machine masquerade through random sequencing of challenges. For example, if a machine or a program impersonates a first time buyer, it will be rebutted with a random sequence or sequences that are impossible or hard to fake without notice of Block 5 and/or Block 4. The challenge sequences may comprise objects such as an image or a movie that are hard or impossible to process in real time by impostor machines.

An embodiment of the invention corresponds to Block 5 receiving from Block 1 through connection 13 a request to re-classify speaker identity for a specified transaction and perform the reclassification. For example, a new user's voice signature is registered in Block 5 whitelist for the first transaction user makes. The voice signature may serve as a reference signature for following transactions of the user. However, if the user is an impostor, the transaction will be rejected post mortem by the credit card company, say after a complaint filed by the original credit card holder. Merchant may then log into the LFP system through Block 1 and ask to move the voice signature from the whitelist to the blacklist and flag the transaction as fraudulent, and add information about the impostor. Block 5 will store all related information to the fraudulent transaction and the impostor.

### Buyer Authentication Process

FIG. 2 is a flowchart diagram presenting the LFP system speaker authentication process in accordance with one embodiment of the present invention. For example, a transaction is started at point 1, where an external application sends a trigger to start a widget or a java script program and convey to it some user identification data, such as id number, full name, credit card number, last few digits of a credit card number and full name and any combination thereof.

Decision point 2 of Block 1 of FIG. 1 acknowledges user id uniqueness and conveys to Block 5 a request to fetch a challenge sequence. Block 1 at point 3 presents to user through external host application the fetched channel sequence. User speaks the challenge sequence which is collected by Block 1 and recorded by Block 2 at point 4. Block 2 associates user and transaction id to recorded voice file at point 5 and moves the recorded file to Block 3. Block 3 extracts voice features and Block 4 and Block 5 analyze voice features, at point 6. Point 7 checks against Block 5 database if it is a first time user. If yes, point 8 saves extracted information for user id in Block 5.

Block 5 may decide in point 9 to acknowledge the transaction, make all necessary bookkeeping at point 17 and report quality factors to external applications or start a re-challenge process at point 9, arbitrarily or based on non-definitive quality factors. For example, a speaker stress factor may be alerting; or, a machine generated sequence is detected for abnormal phrase pronunciation that generates bad quality factors. If a re-challenge sequence is started, Block 5 communicates with Block 6 and Block 1 to convey a new challenge to user through connection 7 and the host external application.

Block 5 carries all the relevant bookkeeping, point 16. If it is not a first time user, point 10 uses history data of specific user to generate quality factor, Block 4 and Block 5. Point 11, Block 5, assess if there is a match between the current user and the voice signature history data of the user. If there is a match, then at point 14, Block 5 decides if to re-challenge user and actions of point 9 are repeated. If there is no match at point 11, Block 5 decides if to terminate transaction and notify external application of an impostor, point 13, or to re-challenge, go to point 16. For example, the decision may be arbitrary or based on a quality factor marginality. At point 14, Block 5 may decide to re-challenge, go to point 16 or report successful transaction authentication to host external application through Block 1 and do the bookkeeping, point 15.

### Challenge Sequence Process

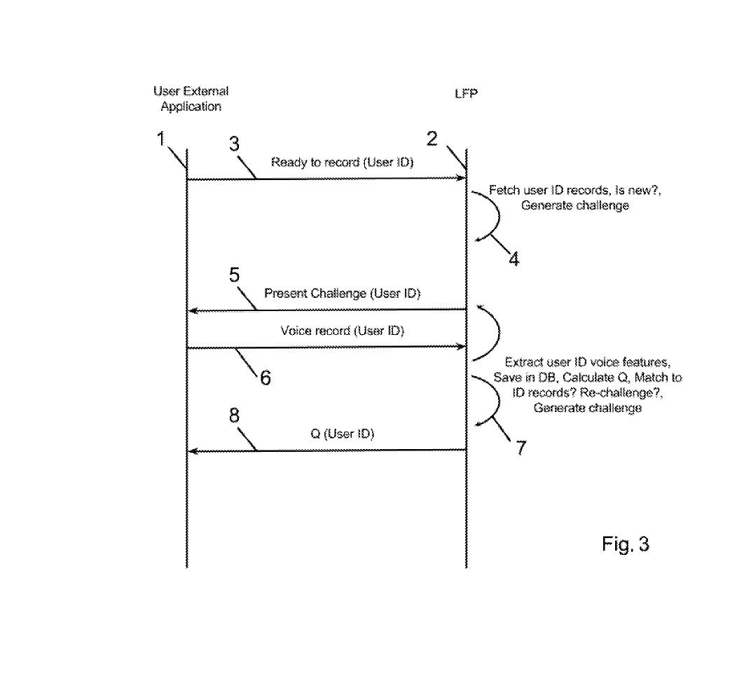

FIG. 3 is a use-case scenario chain of events diagram in accordance with one embodiment of the present invention. Actor 1 is an external application. Actor 2 is an LFP system. Event 3, Actor 1 reports to Actor 2 to authenticate a user by id info. Actor 2 searches if user id is new. Actor 2 generates challenge sequence, Event 4. Event 5, Actor 2 sends challenge to Actor 1 to present to user. Event 6, Actor 1 conveys to Actor 2 voice to be recorded for the user id. Event 7, Actor 2 analyses voice recording, extracts features, saves in database, calculates quality factors, and assesses if to re-challenge. If re-challenge is needed, Actor 2 generates a challenge sequence and goes back to Event 5. Otherwise, Actor 2 reports to Actor 1, Event 8, quality factor for the transaction and the user id.

### Two Different Buyers, Each Conducting a Transaction

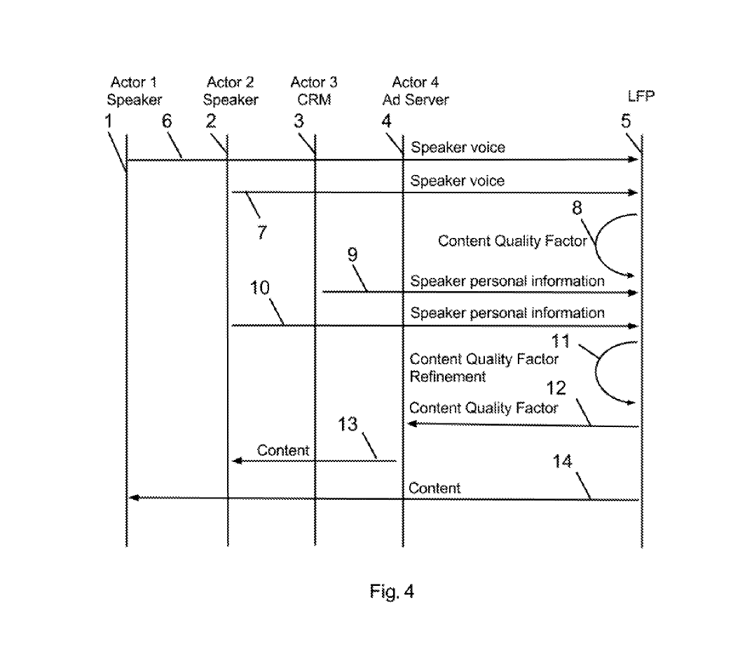

FIG. 4 is a chain of events control diagram presenting an ad serving use case in accordance with one embodiment of the invention. For example, Actor 1 and Actor 2 are each a user, speaker. Actor 3 is a customer relationship management system (CRM). CRM may hold user related information. Actor 4 is an Ad Server that may hold advertising information and provide advertising ability.

Actor 5 is a LFP system. Events 6 and 7 deliver to Actor 5 voice data of two different speakers, each conducting a transaction. For example, both users conduct transactions with the same merchant. Event 8, Actor 5 computes a quality factor that resembles the user's interest in content. Event 9, Actor 5 fetches information about Actor 1 from Actor 3. Event 10, Actor 5 receives from Actor 2 information of Actor 2.

Event 11, Actor 5 generates a refined quality factor based on updated events 9 and 10 and original event 8. Actor 2 delivers quality factor to Actor 4, event 12. Actor 4 serves content to Actor 2, Event 13. Actor 5 serves content to Actor 1, Event 14. For example, the event 14 may be used to convey an advertisement to Actor 1 by means of a new challenge sequence. For example, Actor 5 generates a challenge sequence as follows “Researchers found that intake of vegan omega 3 extracted from Salvia Sclarea yields better results than fish omega 3”.

What is claimed is:

1. A computerized method for generating a new signature of a user to prevent user impersonation, comprising a computer processor steps of,
a. fetching a signal from a non-volatile memory of at least one portion of at least one previously generated user's signature;
b. generating at least one challenge sequence based on the signal to create a new signature;
c. presenting the generated challenge sequence to the user;
d. collecting the user's challenge voice response to the generated challenge sequence; and,
e. computing a quality factor which represents a degree of correlation between any portion of the user's challenge voice response and any portion of the generated challenge sequence;
f. generating a new signature based on any portion of user's challenge voice response and any portion of the previously generated signature and any portion of collectable information from user's device memory; and,
g. storing at least one of, the new signature, the quality factor, and the transaction quality factor in a non-volatile memory.

2. The method of claim 1, wherein each challenge sequence comprises any combination of one or more of textual, visual effects of display, picture, moving picture, video, audio, animation, advertisement format, computer code, computer data objects.

3. The method of claim 1, wherein computing a transaction quality factor which represents a degree of correlation between any portion of the user's challenge response and any portion of a previously generated signature and any portion of collectable information from the user's device memory.

4. The method of claim 1, wherein generating a new signature is further based on information collected from memory of at least one user device.

5. The method of claim 1 wherein generating a new signature is based on any portion of location, device unique parameters, unique program identifier, unique device identifier, user identifying information, user related information fetched from memory of at least one user device.

6. The method of claim 1, wherein generating a new transaction quality factor is based on any portion of location, device unique parameters, unique program identifier, unique device identifier, user identifying information, and/or user related information fetched from memory of at least one user device

7. The method of claim 1 further comprises an events correlation mechanism that checks for use abnormalities of a user and generates a trigger to re-generate a challenge question if an abnormality is detected comprising one or more of: conflicts in a user's known location, current activity, time length of transaction, repetition of visiting a transaction, time lapse between repeated transaction, distribution of transaction locations, speed of movement within same transaction location area, and speed of movement between different transaction location areas.

8. The method of claim 1, wherein a transaction quality factor is a cross platform transaction quality factor related to at least two computer programs the user interacts with through at least one device.

9. The method of claim 1, wherein a content quality factor reflects a user's interest in advertisement that may be presented to user by incorporation within a challenge sequence or by controlling content presented to user.

10. The method of claim 1, wherein any of the quality factor, the transaction quality factor and the content quality factor may be communicated to at least one computer program at any time.

11. A networked based computing system for detecting fraudulent machine or human impersonation of a user, comprising:
a) a system computer comprising at least one processor and at least one memory device operably connected to one another, and a plurality of computer-executable instructions stored on the memory device that when executed by the processor, comprise the steps of:
i. fetching a signal from a non-volatile memory of at least one portion of at least one previously generated user's signature;
ii. generating at least one challenge sequence based on the signal to create a new signature;
iii. presenting the generated challenge sequence to the user;
iv. collecting the user's challenge voice response to the generated challenge sequence;
and,
v. computing a quality factor which represents a degree of correlation between any portion of the user's challenge voice response and any portion of the generated challenge sequence;
vi. generating a new signature based on any portion of user's challenge voice response and any portion of the previously generated signature and any portion of collectable information from user's device memory;
vii. storing at least one of, the new signature, the quality factor, and the transaction quality factor in memory; and,
b) a connection between the system computer and one or more external applications.

12. The system of claim 11, wherein the first and second challenge sequence comprises any combination of one or more of textual, visual effects of display, picture, moving picture, video, audio, animation, advertisement format, computer code, computer data objects.

13. The system of claim 11, wherein computing a transaction quality factor which represents a degree of correlation between any portion of the user's challenge response and any portion of a previously generated signature and any portion of collectable information from the user's device memory.

14. The system of claim 11, wherein generating a new signature is further based on information collected from memory of at least one user device.

15. The system of claim 11 wherein generating a new signature is based on any portion of location, device unique parameters, unique program identifier, unique device identifier, user identifying information, user related information fetched from memory of at least one user device

16. The system of claim 11 wherein generating a new transaction quality factor is based on any portion of location, device unique parameters, unique program identifier, unique device identifier, user identifying information, user related information fetched from memory of at least one user device

17. The system of claim 11 further comprises an events correlation mechanism that checks for use abnormalities of a user and generates a trigger to re-generate a challenge question if an abnormality is detected comprising one or more of: conflicts in a user's known location, current activity, time length of transaction, repetition of visiting a transaction, time lapse between repeated transaction, distribution of transaction locations, speed of movement within same transaction location area, and speed of movement between different transaction location areas.

18. The system of claim 11, wherein a transaction quality factor is a cross platform transaction quality factor related to at least two computer programs the user interacts with through at least one device.

19. The system of claim 11, wherein a content quality factor reflects a user's interest in an advertisement that may be presented to user by incorporation within a challenge sequence or by controlling content presented to user.

20. The system of claim 11, wherein any of the quality factor, transaction quality factor and content quality factor may be communicated to at least one computer program at any time.

21. A networked based computing system for detecting fraudulent machine or human impersonation of a user, comprising:
a) a system computer comprising at least one processor and at least one memory device operably connected to one another, and a plurality of computer-executable instructions stored on the memory device that when executed by the processor, comprise the steps of:
i. fetching signals from memory of at least one portion of any of, previously generated user's signature, previously generated challenge sequence, user identifying information, user related information, user's device identifying information, user's device location, user's device parameters, user's challenge response, quality factor, transaction quality factor, content quality factor, white list, black list, advertisement, content object, user's behavior information;
ii. generating at least one new signature based on the signals;
iii. storing the new signature in memory; and,
b) a connection between the system computer and one or more external applications.

22. The system of claim 21, further comprising the steps of:
iv. generating at least one challenge sequence based on the signals;
vi. presenting the generated challenge sequence to a user, in one of visual, audible or audiovisual format;
vii. collecting a user's challenge voice response to the generated challenge sequence; and,
viii. computing any of a quality factor which represents a degree of correlation between any portion of the user's challenge voice response and any portion of the generated challenge sequence, a transaction quality factor which represents degree of acceptance or rejection of an online transaction, a content quality factor which represents the degree of user's interest in content presented to the user, a white lists which represent legitimate users, a black lists which represent impostors or non-legitimate users; and,
ix. storing at least one of, the challenge sequence, challenge response, quality factor, transaction quality factor, content quality factor, white list and black list in memory.

23. The system of claim 22, wherein the transaction quality factor is a cross platform transaction quality factor related to at least two computer programs the user interacts with through at least one device.

24. The system of claim 22, further comprising the steps of:
i. any one of generating, fetching from memory, receiving from external applications at least one content object or advertisement related to content quality factor; and,
ii. presenting the content object or advertisement to the user, in one of visual, audible or audiovisual format.
